(19) United States
(12) Patent Application Publication
(10) Pub. No.: US 2014/0257799 A1
(43) Pub. Date: Sep. 11, 2014

(54) SHOUT MITIGATING COMMUNICATION DEVICE

(71) Applicant: Daniel Shepard, North Hampton, NH (US)

(72) Inventor: Daniel Shepard, North Hampton, NH (US)

(21) Appl. No.: 13/790,058

(22) Filed: Mar. 8, 2013

(51) Int. Cl. G10L 21/0324

(52) U.S. Cl. CPC G10L 21/0324
USPC 704/206

(57) ABSTRACT

The present invention is a means to provide a user interface that will naturally cause a person to speak at a normal talking volume. It is based on a mechanism whereby the user's speech is compared to a threshold to determine if the user is speaking too loudly and provides feedback to the user. This mechanism could be incorporated into a headset, a cell phone, a smartphone, or into other communication devices. It is useful for operation with or without a headset.

### CROSS REFERENCE TO RELATED APPLICATIONS

This application makes reference to U.S. Provisional Patent application 61/634,982 by Shepard titled “NOISE CANCELING HEADSET” which was filed on Mar. 8, 2012 and which is incorporated herein in its entirety by reference.

### REFERENCE REGARDING FEDERAL SPONSORSHIP

Not Applicable.

### STATEMENT REGARDING FEDERALLY SPONSORED RESEARCH OR DEVELOPMENT

Not Applicable.

### FIELD OF THE INVENTION

The present invention relates to headsets, and more particularly to headsets for use with cell phones.

### SUMMARY OF THE INVENTION

Cell phones have been around for a few decades. As they become smaller and cheaper, people have become dependent upon them. One side effect of this is that people talk on their cell phones at all time of the day and night and wherever they go. Often, people tend to speak at a louder volume than they typically speak in normal conversation with other people. This is frequently a problem for those people close by.

Several solutions to this loud talking on cell phones have been devised ranging from laws banning the use of cell phones to radio frequency jammers that disable the cell phone's operation. Neither solution is necessary—the noise that needs to be canceled is the sound of the person speaking that reaches those near by. People speak all the time without disturbing those around them. However, when many people speak on a cell phone, they speak at an elevated voice level even though cell phones can receive and process a voice that is spoken at a normal speaking level. The present invention is a headset and/or a cell phone that provides a user interface that will naturally cause a person to speak at a normal talking volume. The present invention provides feedback to the user that indicates to that user if his or her level of speaking is too loud.

### BRIEF DESCRIPTION OF THE DRAWINGS

FIG. 1 depicts a a block diagram of the present invention

FIG. 2 depicts a block diagram for a noise canceling headset.

FIG. 3 depicts a block diagram for a noise canceling headset incorporating the present invention.

FIG. 4 depicts a flow chart for a smartphone incorporating the present invention.

### DESCRIPTION OF THE PREFERRED EMBODIMENT

The present invention is an enhancement to a noise canceling headset, or it could be implemented within a cell phone or other communication device such that it could be used with or without a headset.

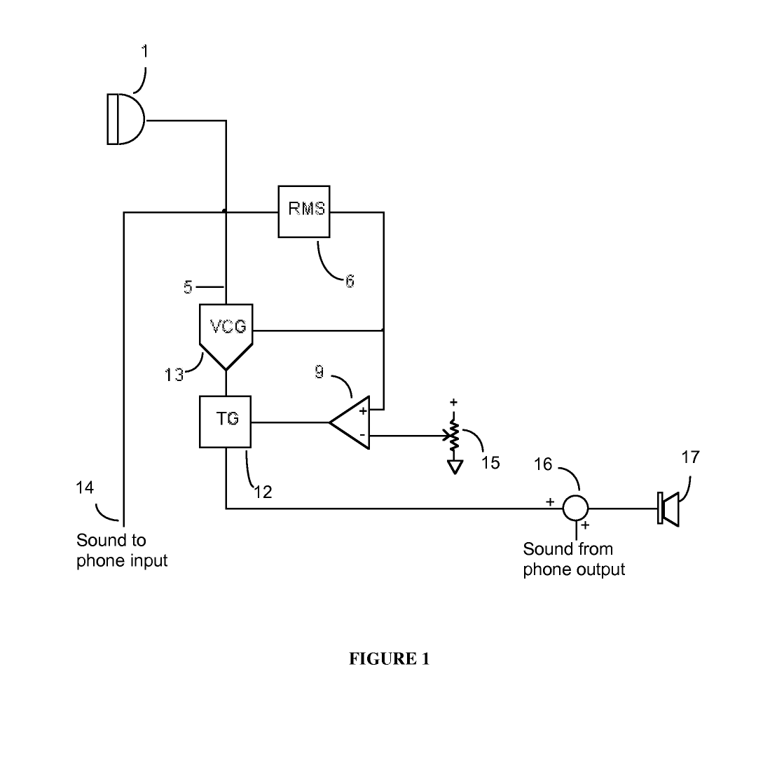

FIG. 1 depicts a basic implementation of a preferred embodiment of the present invention. This circuit would form a path between the microphone and the earpiece of the communications device. It can be build in the handset or in a headset. In this embodiment, the microphone 1 picks up the voice signal spoken by the user of the communication device. This voice signal is present on a node 5 where it can be provided to the communications device's normal voice signal input 14, but it is also provided to the input of a RMS power circuit 6 (or a circuit that generally that determines the volume of the speaker's voice within the voice signal as are well known to those skilled in the art—this could be no more than a full or half wave circuit followed by a low pass filter), and to the input of a Voltage Controlled Amplifier 13 that provides Voltage Controlled Gain. The RMS power circuit 6 output provides a voltage to the gain control input of the Voltage Controlled Amplifier 13 that is generally proportional to the amplitude of the input voice signal (i.e., the loudness of the speaker). The RMS power circuit 6 output also goes to a comparator 9 to compare the amplitude to a level that can be fixed or adjustable (as depicted by variable resistor based reference voltage source 15) such that when the voltage corresponding to the loudness of the speaker's voice within the voice signal exceeds that fixed or variable level, comparator 9 will provide the control input to a transmission gate 12 which passes the outputs the signal from the Voltage Controlled Amplifier 13 to a point where this signal can be summed by a summing circuit 16 into the signal to a listening device 17 (speaker, headset, etc.) for the communications device. This circuit can be further simplified by removing the transmission gate 12 and comparator 9 which is the functional equivalent of setting the level of reference voltage source 15 to its lowest level such that transmission gate 12 is always on; in this configuration, the Voltage Controlled Amplifier 13 could also be a non-linear gain device (at low, normal speaking volumes, the output signal is so small that it is barely noticeable where at loud speaking volumes it becomes very noticeable and even distracting). In this latter configuration, the the relationship of the gain of the Voltage Controlled Amplifier 13 to its voltage control input would be pre-set or could be programmable.

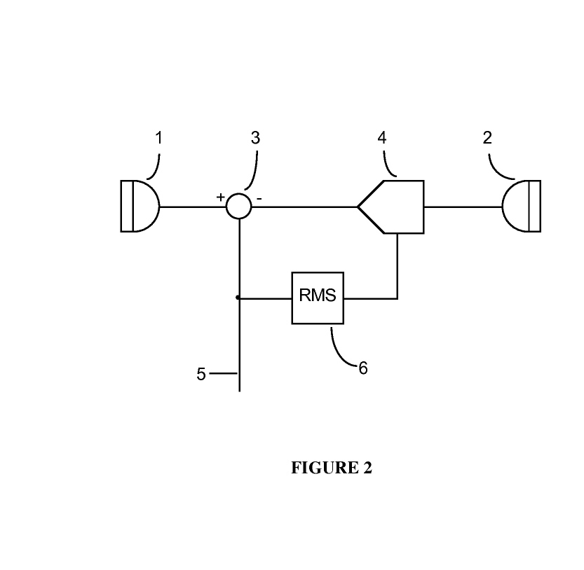

FIG. 2 depicts a basic noise canceling circuit. Voice is picked up at microphone 1 along with background noise. Microphone 2 is positioned to pick up less of the user's voice, typically by its placement in the headset or in the communication device. By subtracting the background signal of microphone 2 from the signal of microphone 1 with a summing junction 3 (as is well known to those skilled in the art) the background noise at the negative input will generally cancel out the background noise at the positive input leaving mostly the voice to be output at 5. Improvements in noise canceling circuits adds a voltage controlled amplifier 4 where the gain is controlled by a feedback path through the RMS power circuit 6 (which could be no more than a half-wave rectification of the output with a low pass filter). As the output at 5 increases (due to an increasing background noise component), the Voltage Controlled Gain increases causing the amplitude of the background noise subtracted to also increase. This reduces the amount of background noise at the output. Additional filtering is also employed (e.g., filters that pass those frequencies typical of human voice more readily than others).

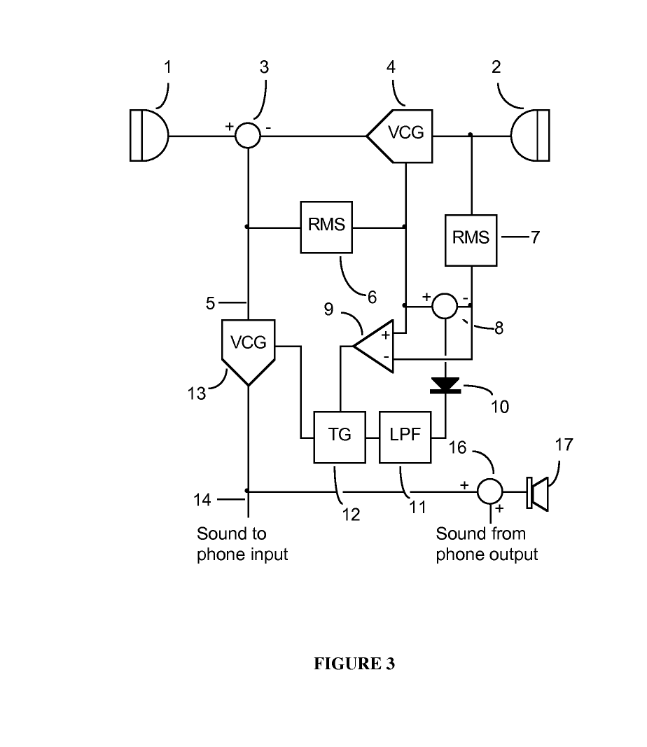

FIG. 3 depicts a basic noise canceling circuit with the addition of the present invention. Here, the output at 5 (as depicted in FIG. 2) is passed through a Voltage Controlled Amplifier as well where the Gain Control comes from the output of transmission gate 12. This transmission gate is switched ON by comparator 9 when the average power output of the output signal 5 (as determined by RMS power circuit 6 as done in the basic noise canceling headset example in FIG. 1) is greater than the average power output of the background noise input signal from microphone 2 (as determined by RMS power circuit 7). The difference between average power output of the output signal 5 and the average power output of the background noise input signal from microphone 2 is determined by summing node circuit 8. This power difference is provided to the input of transmission gate 12. A rectifier 10 can be optionally included to only allow positive output signals (i.e., only those signals when the average power output of the output signal 5 is greater than the average power output of the background noise input signal from microphone 2). In this way, the noise canceled voice signal on the output 5 can be sent to the microphone input 14 of the communication device as before, but an enhanced voice signal will also be available at the output of Voltage Controlled Amplifier 13. This enhanced voice signal can be added to the sound to be output by the communication device (e.g., through the ear piece or speaker 17). When the average power output of the output signal 5 is less than the average power output of the background noise input signal from microphone 2, the output of comparator 9 is off and the transmission gate 12 is turned off (the Voltage Controlled Amplifier 13 has minimum gain). However, when the average power output of the output signal 5 is greater than the average power output of the background noise input signal from microphone 2, as would be the case when the user is speaking louder than the background noise environment would require, the user would hear his or her own voice in the ear piece. Furthermore, the extent to which the user exceeds the speaking volume required given the environmental background noise, the louder his or her own voice becomes. This feedback of the user's own voice can be non-linear such that as the user exceeds the required speaking volume level (given the environmental background noise) more and more, the increase in the volume of his or her own voice in the ear piece increases at a greater rate.

When a speaker starts hearing his or her own voice, he or she starts reducing his or her speaking volume. The result of using the present invention will be to cause the user to maintain a speaking voice amplitude that is commensurate with the level of background noise.

The present invention can likewise be implemented via a software routine in a digital communication device such as a smartphone. Generally speaking, as is well understood by those skilled in the art, in a smart phone, voice is processed in small packets. These packets are essentially a few milliseconds of sound and they are copied to and from buffers implemented by the smartphone system software. Sounds received (i.e., from a cell tower transmission) are placed in a receiving buffer, sounds “heard” (i.e., sounds received through the smartphone's microphone and digitized) are placed in a microphone buffer, and sounds to be played (e.g., output by a speaker or headset) are put into an output buffer. These placements are managed by the smartphone's hardware and software. Typically and generally, the receiving buffer is copied to the listening buffer and the microphone buffer is processed and transmitted to the cell tower for remote reception. The microphone buffer data is typically not copied to the listening buffer in a smartphone. Additional sounds to be played are overlayed by adding the signal of the overlay sound to other sounds placed into the output buffer. Amplitude is controlled by scaling the bytes of sound data.

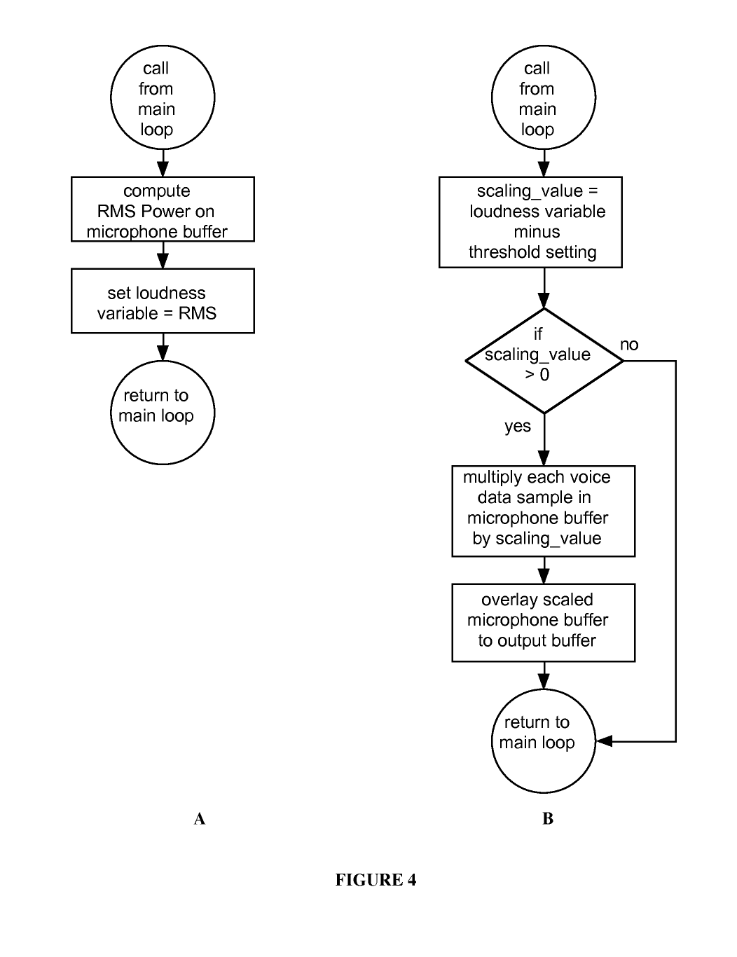

FIG. 4 depicts a generalized functional flow chart for a software implementation of the present invention. In the main loop of the smartphone software routine, a first routine, A, monitors the sound data in the microphone buffer and analyzes it for “loudness” (e.g., it performs a signal power analysis routine such as a simple RMS power algorithm ranging up to even a Fourier Transform (FFT) analysis of the typical speaking frequencies as are well known to those skilled in the art) and sets a variable to indicate and retain the current speaking volume or loudness level. Since the volume of a speaker typically does not vary quickly, this routine can have a lower priority and need not process every packet of voice data coming from the microphone to determine the current speaking volume or loudness level of the speaker. A second routine, B, examines the loudness variable and compares it to a threshold setting (configured in the phone's settings application or “app”); if the loudness variable indicates that the speaker is speaking at a volume greater than the maximum volume configured in the threshold setting, the microphone buffer is scaled by the difference between the loudness variable and the threshold setting, and the result of the scaling is overlayed (added) to the output buffer. Numerous alternate computational approaches can be implemented to make the resulting feedback more evident to the user such as squaring the difference between the loudness variable and the threshold setting or otherwise making the scaling factor a nonlinear function of the microphone level.

Many alternatives will come to mind in light of the above teaching. One alternative would be to place the transmission gate 12 in the path of the output from Voltage Controlled Amplifier 13 instead of between the gain control input of Voltage Controlled Amplifier 13 and the output of Low Pass Filter 11. Another would be to use the output signal from comparator 9 to switch on a tone or other audible signal (e.g., a recorded voice reminder to speak more softly) or to activate a vibration device (i.e., the vibration ringer motor in the cell phone) or a miniaturized vibration motor in the noise canceling headset. Alternatively, an additional step in the software routine (FIG. 4-B) to be executed if the variable scaling_value is greater than zero that will overlay an additional tone or other audible signal (e.g., a recorded voice reminder to speak more softly) or to activate the smartphone's vibration device (i.e., the vibration ringer motor) or to activate a miniaturized vibration motor in a noise canceling headset. Either of these alternate signaling mechanisms, together or separately, could be implemented with or without the user's own voice feedback mechanism. An additional alternative would be to exclude the average power output of the background noise input signal from microphone 2 and, instead, set a fixed threshold level or a settable or programmable threshold level (this would obviate the need for the second microphone in instances where the device is to be located in the communication device, as depicted in FIG. 3).

The foregoing description of an example of the preferred embodiment of the invention and the variations thereon have been presented for the purposes of illustration and description. It is not intended to be exhaustive or to limit the invention to the precise forms disclosed. Many modifications and variations are possible in light of the above teaching. It is intended that the scope of the invention be limited not by this detailed description, but rather by any claims appended hereto.

I claim:

1. A voice input device comprising a voice input signal, means to determine the loudness level of said voice input, means compare said loudness level to a threshold level, and means to selectively output the voice input signal to a listening device in combination with other sound being output on said listening device.

2. The voice input device of claim 1 whereby said device is used with a communication device.

3. The voice input device of claim 2 whereby said communication device is a wireless telephone.

4. The voice input device of claim 2 whereby said device is located in the communication device.

5. The voice input device of claim 2 whereby said device is located in a headset to be used with said communication device.

6. The voice input device of claim 1 further comprising an alerting mechanism to alert the user.

7. The voice input device of claim 6 whereby said alerting mechanism comprises a vibration device.

8. The voice input device of claim 6 whereby said alerting mechanism comprises a recorded or synthesized sound.

9. The voice input device of claim 8 where said recorded or synthesized sound is speech.

10. The voice input device of claim 1 further comprising means to detect the level of ambient background noise of the user's environment.

11. The voice input device of claim 10 where the signal level of the voice input signal is a nonlinear function of the loudness level of the voice input and the level of ambient background noise.

12. The voice input device of claim 12 where the user's voice is not fed back when the user is speaking at a volume level below what is necessary for clear reception given the level of ambient background noise.

13. The voice input device of claim 12 where the user's voice is fed back when the user is speaking at a volume level below what is necessary for clear reception given the level of ambient background noise.

14. The voice input device of claim 1 whereby said device is comprised by a smartphone.

15. The voice input device of claim 14 whereby the device is implemented by software.

16. The voice input device of claim 1 whereby the device is implemented by hardware.
